(19) United States
(12) Patent Application Publication
(10) Pub. No.: US 2016/0378728 A1
(43) Pub. Date: Dec. 29, 2016

(54) SYSTEMS AND METHODS FOR AUTOMATICALLY GENERATING CONTENT MENUS FOR WEBCASTING EVENTS

(71) Applicant: InXpo, Inc., Chicago, IL (US)

(72) Inventor: Jeff Pryhuber, Lake Zurich, IL (US)

(73) Assignee: InXpo, Inc., Chicago, IL (US)

(21) Appl. No.: 14/747,619

(22) Filed: Jun. 23, 2015

(51) Int. Cl. G06F 17/22; H04L 29/06; G06F 3/0484; H04L 29/08; G06F 3/0482

(52) U.S. Cl. CPC G06F 17/2247; H04L 67/02; G06F 3/0482; G06F 3/04842; H04L 65/4076

(57) ABSTRACT

A webcasting system that provides a webcast presenter and webcast attendees with multiple interactive means of connecting and communicating is disclosed. A webcast presenter may create and send webcast slides, which include references to dynamic and interactive content, to webcast attendees. Attendees may view the webcast slides and interact with the dynamic and interactive content provided through the references. Webcast presenters may control an attendee's ability to interact with the interactive content. Additionally, webcast presenters may allow attendees to break away from a main webcast presentation into smaller presentation or group.

### FIELD OF THE INVENTION

Aspects of the present invention relate to webcasting, and in particular, to a system and method for providing interactive webcasting and content menus for interactive webcasting.

### BACKGROUND

Webcasting has become a mainstream method for delivering information to a large audience over the Internet. Through the creation of a webcast presentation, a presenter can present topic driven media and related information over a communication network to a large number of viewers, both in real-time or on-demand. For example, a University may offer on-line courses in which the instructor webcasts a pre-recorded or live lecture, a business enterprise may webcast a press conference in lieu of or in addition to a conference call, or a commercial organization may webcast a product sales promotional presentation.

Although numerous webcasting products and systems exist in the marketplace, several aspects of existing webcast products limit their potential use. First, present webcasting products only offer the ability to display static content to viewers. For example, many existing webcast products are developed in flash, which limits what can be rendered by the webcast system to only a video or an image, neither of which viewers may interact with. Accordingly, existing webcasting systems provide a monotonous experience to viewers, as they are functionally incapable of allowing viewers to dynamically interact with the content being presented through the webcast. Another aspect that has limited the potential use of existing webcasting products is the inability for webcast presenters to manage viewers. Existing webcasting products limit an individual viewer's experience to a standard presentation that every webcast viewer must experience at the same time. For example, webcast presenters cannot break viewers into smaller groups during a webcast. Accordingly, it is desirable to create webcasting methods and systems with these issues in mind.

### SUMMARY

Aspects of the present disclosure involve methods, systems and/or computer-readable mediums for providing interactive content in a webcast that may be implemented and/or executed using one or more computing devices. In one embodiment, providing the interactive content in a webcast includes obtaining one or more references providing access to interactive web content. Providing the interactive content may further include generating one or more webcast slides, each of the one or more webcast slides to be rendered inside a self-contained frame, the webcast slide representing the interactive web content accessible through at least one of the references, the one or more webcast slides enabling at least one attendee to access and interact with the interactive web content through the frame. Providing the interactive content includes providing for pushing the one or more webcast slides to the self-contained frame in a host container page of a webcast presentation and generating a chaptering menu corresponding to the webcast presentation, wherein the chaptering menu includes one or more entries corresponding to a topical interest of the one or more webcast slides.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 is a block diagram of an example computing system for providing interactive content during a webcast, according to one embodiment.

FIG. 2 is a block diagram of an interactive webcast application, according to one aspect of an interactive webcast system.

FIG. 3A is a block diagram illustrating a webcast slide, according to one embodiment.

FIG. 3B is a block diagram illustrating a chaptering menu and/or content menu, according to one embodiment.

FIG. 4 is a flowchart illustrating a method form for providing interactive content during a webcast, according to one embodiment

FIG. 5 is a flowchart for providing interactive content during a webcast, according to one embodiment.

FIG. 6A provides an example illustration of a process for updating a chaptering menu based on a webcast presentation, according to one embodiment.

FIG. 6B is a block diagram of a messaging system, according to one embodiment.

FIG. 7 is a flowchart illustrating a process for enabling remote attendees interacting with mobile devices to participate in webcast presentations, according to one embodiment.

### DETAILED DESCRIPTION

Aspects of the present disclosure involves an interactive webcast system that provides interactive web content to attendees during a live and/or on-demand webcast presentation. Generally speaking, a webcast or webcast presentation describes the activity of employing a communications network, such as the Internet, to deliver real-time live or delayed versions of audio, video, interactive media, data and/or the like, in the form of a presentation, to one or more viewers.

In various aspects, the disclosed webcast system automatically generates and manages webcast presentations. More specifically, users of the interactive webcast system, such as webcast presenters, generate one or more webcast slides for a given webcast presentation that allow attendees of the webcast presentation to access external interactive web content that was not originally included as a part of the webcast presentation. The presenters may also direct and manage the interactive content that attendees are able to view and access during a webcast presentation. For example, presenters may direct attendees in and out of the main webcast presentations and sub-presentations known as breakout sessions.

Other aspects of the present disclosure involve the automatic and dynamic generation of a preview content menu (e.g., a dynamic table of contents) for a webcast presentation, referred to herein a “chaptering menu” that is reflective of the information and/or content (e.g., webcast slides) currently being presented, or scheduled to be presented, via the webcast presentation. The chaptering menu may be engaged by users to navigate through various topical points of interest of the live webcast presentation. More specifically, users may selectively navigate the chaptering menu by selecting or otherwise flagging various entries included or otherwise displayed in the chaptering menu that correspond to the topical points of interest of the webcast presentation. Thus, instead of interacting and/or otherwise participating in a webcast presentation without any indication of the next topical point of interest that the presenter is going to discuss or otherwise present, users can interact with the chaptering menu to see what webcast content has already been presented; what content is currently being presented; and what content is coming next, thereby holding the user's attention until the desired portion of the webcast presentation is presented.

Aspects of the present disclosure further involve a mechanism, accessible on a mobile device, that allows attendees of a given webcast presentation to participate in the webcast presentation from a remote location. More specifically, the webcast systems described herein communicate with a mobile device (e.g., via a web browser) to broadcast portions of the content of the webcast presentation in a manner that is more visually appealing and optimized for the specific technical features of each respective mobile device (e.g., bandwidth constraints, display size, security, etc.). For example and in one embodiment, the disclosed systems may inhibit video feeds and access in an effort to conserve bandwidth. Additionally, slide content may be limited as well, such as for example, only allowing users to poll, submit and receive question and/or answers, engage in chat activities, and/or the like. Thus, the disclosed systems may enable many users to watch a live and interactive presentation, such as for example, a presentation displayed on a stage and still participate in the interactive portion of the presentation.

An end-user (webcast attendee) interfacing with a website browser application accesses the content and interacts with the webcast presentation. For example, in some embodiments, users (remote attendees) may use their mobile devices to provide real-time questions and/or comments in the form of messages to a moderator or presenter in charge of providing the webcast presentation. The questions and/or comments may be processed and responded to directly as part of the live webcast presentation session, or for future on-demand playback. The mobile device users may be live attendees, or may be virtual, or combinations of the two, that listen to the presenter. The audience is the larger population that receives information from the speaker; i.e. it can include the live people attending a meeting in a conference, but can also include dozens or hundreds of such mobile device users. In one embodiment, the web cast presentation need not necessarily be live—a recorded program can be presented with the opportunity for audience members to ask questions and receive answers from a speaker who is neither attending nor online, but rather receives the questions via Internet and responds as convenient.

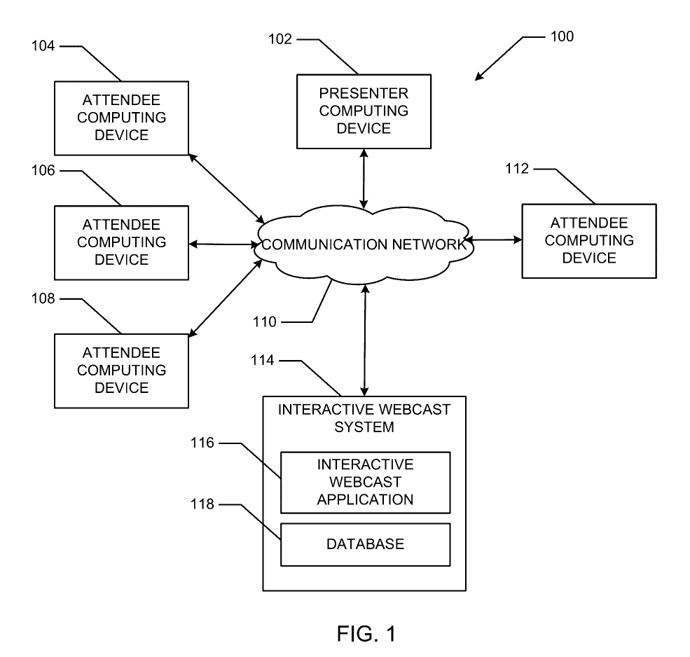

FIG. 1 is system diagram of one possible implementation of a computing environment 100 for providing interactive content during a webcast. The computing environment 100 includes a presenter computing device 102, attendee computing devices 104, 106, 108, and 112, and an interactive webcast system 114 (“IWS”) that is configured to initiate, manage, and control one or more live webcast presentations and/or on-demand webcast presentations. According to one aspect, each computing device is a computer or a processing device, such as a personal computer, a server computer, or a mobile processing device. Each computing device includes one or more processors that process software or other machine-readable instructions and includes a memory to store the software or other machine-readable instructions and data. The memory may include volatile and/or non-volatile memory. Each computing device may also include a communication system to communicate via a wireline and/or wireless communications, such as through the Internet, an intranet, and Ethernet network, a wireline network, a wireless network, and/or another communication network. Each computing device may further include a display for viewing data, such as a computer monitor, and an input device, such as a keyboard or a pointing device (e.g., a mouse, trackball, pen, touch pad, or other device) for entering data and navigating through data, including exams, images, documents, structured data, unstructured data, HTML pages, other web pages, and other data.

Each computing device is communicatively connected to the IWS 114 through a communication network 110, such as a wide area network or via the Internet. Furthermore, data may proceed over paths that involve wire and wireless networks, both private and public. Various levels of access to the computing environment 100 may be provided through a password and user ID.

The presenter computing device 102 is associated with a webcast presenter desiring to create and control a webcast providing interactive web content. A presenter represents a person or organization responsible for running an event, or webcast. For example, a chief executive officer for a large corporation may be the presenter of a webcast. As another example, the dean of a University may be the presenter of a webcast.

The presenter may access a website through a browser using the presenter computing device 102 to access the ISW 114 to create and control webcast presentations providing interactive web content. The presenter then uses the keyboard and/or mouse associated with the presenter computing device 102 to create and/or import webcast slides that allow webcast attendees the ability to access and interact with interactive web content displayed through the webcast. Interactive web content may include any type of interactive or dynamic content accessible through the Internet such as: multimedia presentations, video, audio, interactive slides, chat, text, live websites, desktop sharing modules, linkage to third party webcasts, and access to virtual event platforms. In one aspect, any type of interactive web content may be accessed. In another aspect, interactive content may be generated from any form of many conventional sources such as a digital camera, camcorder, audio recorder, CD, DVD, computer, etc. Once such interactive content has been generated, the data may be entered as presentation data into the IWS 114. In one aspect, the presenter computing device 102 may be used to enter to create webcast slides before a presentation goes live, create and control webcast slides during a live presentation in real-time, or a combination of both.

For example, the dean of the University may use the presenter computing device 102 to generate a webcast slide allowing access to a University admitted student virtual tour platform. Additionally, the dean may create a webcast slide during a live webcast that allows students to access the university registration class website, allowing the students to interact with the website and register for classes during the webcast. As another example, a chief executive officer may create webcast slides for a corporate webcast that allow attendees to access and edit external corporate documents. Alternatively, the chief executive office may create a webcast slide that allows webcast attendees to access private and proprietary corporate systems.

The attendee computing devices 104, 106, 108 and 112 are associated with a webcast attendee or viewer, who intends to interact with the webcast presented by a presenter. For example, an attendee may access a webcast presented by a presenter by accessing a website associated with the webcast through a web browser at an attendee computing device. In one aspect, the attendee may provide account information such as a user name and login in order to access the webcast through the web browser. Once the webcast has been validly accessed, an attendee may, for example, use the keyboard and/or mouse associated with an attendee computing device 104, 106, 108, or 112 to interact with any of the interactive content displayed through the webcast offered by a presenter. While only four attendee computing devices are shown in computing environment 100 depicted in FIG. 1, it should be appreciated that the number of viewers could be tens, hundreds, thousands, or more. In one aspect, any person with access to the Internet may be a potential viewer of the interactive webcast presentation.

Referring again to the University example, an attendee of the University webcast may use the attendee computing device to access the university class registration page and register for classes. Referring to the corporate example, an attendee of the corporate webcast presented by the chief executive officer, may apply for promotions by interacting with the corporate website accessible through a webcast slide using an attendee computing device 104, 106, 108, and 112.

The IWS 114 includes an interactive webcast application 116 to generate one or more webcast slides comprising interactive webcast content. For example, the IWS 114 may generate a webcast slide allowing attendees to access external websites through the webcast slide during a live webcast. As another example, the IWS 114 may generate a webcast slide allowing attendees to access and interact with a 3^{rd} party virtual event platform and functionality. According to another aspect, the interactive web application 116 allows presenters to control a webcast attendee's ability to view, access, and interact with the interactive web content of a webcast slide during a live presentation. According to yet another aspect, the interactive web application 116 allows presenters to push and pull attendees into webcast slides known as breakout sessions. For example, a presenter may recreate a classroom setting by offering webcast attendees a way to break-away from the main presentation and interact in small groups. Although the IWS is described in connection with generating webcast slides that provide access to interactive web content, it is contemplated that the methods and systems described herein may be applied to generate webcast slides providing access to static web content.

For example, the during the university webcast, the dean (presenter) may push webcast attendees such as students into breakout sessions relating to a student's academic studies. Thus, an engineering webcast attendee may be pushed to a breakout session webcast slide offering access to interactive web content relating to engineering studies.

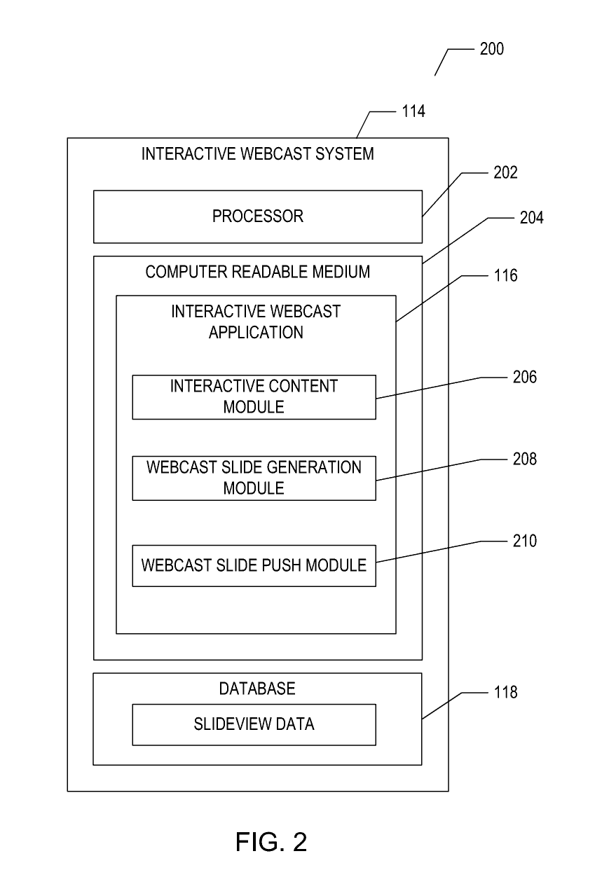

FIG. 2 is a block diagram that depicts an example IWS 114. According to one aspect, the IWS 114 includes a processor 202 that executes an interactive webcast application 116 to generate an interactive webcast. The processor 202 may include memory as well as other computing components and may reside on a computer, or other processing system. The IWS 114 may also include a computer readable media (“CRM”) 204 configured with the interactive webcast application 116. The IWS 114 may include a database 118 to store webcast slide data. According to one aspect, database 118 is a general repository of data including but not limited to interactive content, web content, webcast slides, webcast slide data, and any other type of interactive webcast presentation data. The database 118 may include memory and one or more processors or processing systems to receive, process, query and transmit communications and store and retrieve data. In another aspect, the database 118 may be a database server.

The interactive webcast application 116 includes instructions or modules that are executable by the processor 202. For example, in one embodiment, the interactive webcast application 116 includes an interactive content module 206, a webcast slide generation module 208, and a webcast slide push module 210. Other modules may also be included.

The interactive content module 206 obtains references to interactive content to be presented in an interactive webcast. A reference refers to an access point, pointer, link, portal, etc., that offers or otherwise provides and links or accesses interactive web content. For example, the interactive content module 206 may obtain uniform resource locators (URLs) that provide access to specific interactive content such as multimedia presentations, video, audio, interactive slides, chat, text, live websites, desktop sharing modules, access to third party webcasts, and access to internal and/or external virtual event platforms. For example, the webcast may be a component of a virtual event platform and a reference to other areas of the virtual event platform may be obtained. A URL is an address that can be used to access objects, data, websites, etc., on the web, or through other information systems.

For example, if the webcast were a corporate presentation to potential and existing employees, references to interactive content could be obtained such as URLs and links to external and existing corporate websites, corporate online games, presentations, etc. In another example, a digital video camera could be used to record the live video presentation of the chief executive officer (a type of presenter). Subsequently, the video could be stored on a server, and a reference to the video could be obtained by the interactive content module. A presenter, such as the chief executive officer may then create webcast slides including the reference to the interactive content within a frame, and push the webcast slides to attendees during a webcast. Attendees may access and interact with the web content accessible through the reference.

The webcast slide generation module 208 generates a webcast slide that incorporates the interactive content received by the dynamic content module 208 and stores the webcast slide in the database 118. In one aspect, the webcast slide is a self-contained webpage URL, rendered inside its own frame that allows for linkage to any external web content, such as interactive web content. For example, each webcast slide may be rendered in an HTML iframe. An HTML iframe is an inline frame embedded into a webpage or container page that contains content which is external to the webpage in which the iframe is currently embedded. Essentially, iframe functionality allows for access to external web content from a main webpage or container page. Thus, the iframe can link to any external web-based content accessible through the Internet or other network. When a webcast slide URL is rendered inside an iframe or slide area frame in the webcast, the webcast slide allows for access to any content retrievable through the specified URL, including interactive content. Once the webcast slides have been created an attendee of the webcast, using an attendee computing device, may interact with the content accessible through the webcast slide. Although the above examples have been described using HTML iframes, any suitable markup language or programming language capable of creating iframes, or iframe type functionality may be used.

In another aspect, the webcast slide generation module 208 may generate multiple webcast slides implemented as a list of URLs, and store the list in the database 118. The webcast slides are implemented as a list of URLs to be pushed to a webcast container page or slide area frame. In one aspect, the push mechanism is implemented using a message passing system. A message is sent from a presenter computing device, to a webcast system or application, such as IWS 114. The IWS subsequently communicates the message received from the presenter computing device to all of the webcast attendees, instructing the attendee's computing device to navigate an iframe represented within the webcast system to the specified slide. Thus, when a presenter pushes a webcast slide, a message is sent to attendees at attendee computing devices 104, 106, 108 and 112 instructing a host container page on which the webcast slide is displayed to navigate the webcast slide to the specified URL represented in the webcast slide. For example, a webcast slide S is created as a self-contained webpage URL linking to a corporate multimedia website. A presenter pushes the webcast slide S to the webcast host container page frame, which navigates to the specified URL. Any attendee viewing the webcast may now interact with the corporate multimedia website through the webcast slide. In another aspect, the webcast slide may be identified by a key value in the message. Accordingly, a webcast slide may be retrieved from the database 118 based on the key value, pushed to attendee computing devices and rendered in the appropriate iframe.

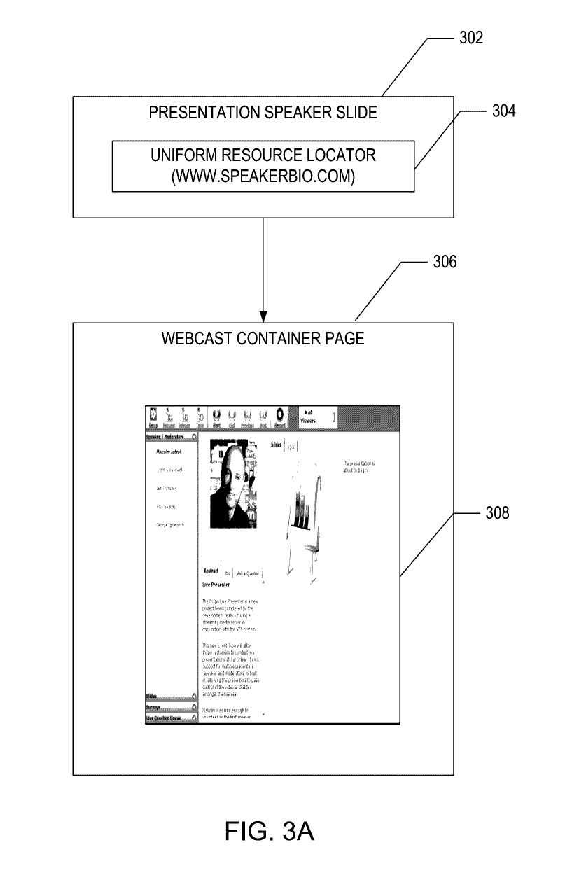

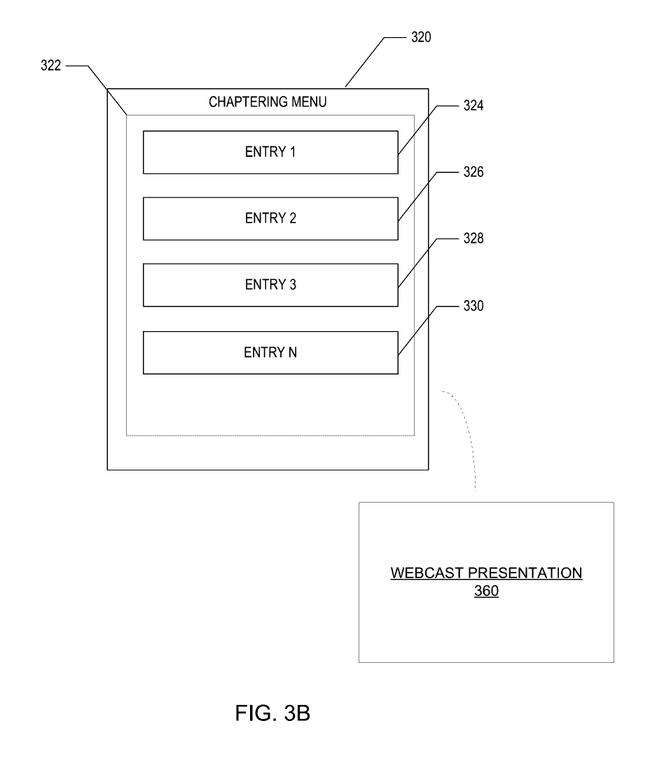

FIG. 3A is an example illustration of a webcast slide being rendered inside its own frame. An example URL linking to a speakers biography webpage received by the webcast generation module 208 is depicted at 304. The webcast slide generation module generates a webcast slide 302 incorporating the URL 304. During the live webcast, the webcast slide 302 renders the URL 304 inside its own frame 306, embedded inside a host or container webcast page, allowing attendees to interact with the interactive web content 308 accessible through the URL 304.

Referring back to FIG. 2, the webcast slide push module 210 allows a presenter to manage and control webcast slides that are presented to attendees. For example, a presenter may push different webcast slides to attendees throughout a live webcast as described above. As a presenter pushes different webcast slides to the attendees, attendees may view and hear the presenter through streaming video and audio feeds of the webcast, allowing the presenter to provide comments and directions about how attendees should interact with interactive content being displayed in real-time.

In another aspect, the webcast slide push module 210 allows a presenter to create a classroom setting by offering attendees the ability to break away from the main webcast presentation into a breakout session, consisting of two or more attendees. A breakout session is a particular type of webcast slide that allows an attendee to interact with a limited number of attendees separate from the main presentation. In one aspect, a breakout session may be accessed through a webcast slide like any other interactive content. For example, attendees may access a breakout session by clicking a specific URL in webcast slide. Once an attendee accesses the URL, the attendee is advanced to a interactive content representing a breakout session. For example, the breakout session may be a show feature or a booth (a show feature or booth is a space within a virtual event platform or environment of which a webcast is a component), or a live chat or video-conferencing room. In another aspect, the presenter may populate the breakout room with content, such as video, audio, or any other type of interactive content. Attendees may be assigned to a breakout session by a presenter, or an attendee may choose to enter a breakout session. Alternatively, attendees may be pulled back to the main presentation by presenters, or an attendee may choose to leave a breakout session. Once an attendee has accessed a breakout session, the attendee may interact with other attendees in the same breakout session through audio, video, chat, etc.

In another aspect the webcast slide push module 210 allows a presenter to control how attendees may interact with the content accessible through a webcast slide. For example, if a webcast slide presents an external interactive website, the presenter may deactivate any access to the interactive components of the interactive website, such as games, videos, links, etc. At a later time, the presenter may reactivate the interactive components. In one aspect, the presenter may click an enablement checkbox option that has been defined in the webcast slide. Subsequently, a transparent layer that intercepts all click actions and keystrokes is created and placed over the interactive content accessible through the webcast slide, thereby rendering the live content as view-only. In one aspect, the transparent layer implemented using a HTML DIV element, which may be used to define a division or a section in an HTML document and/or format them with styles.

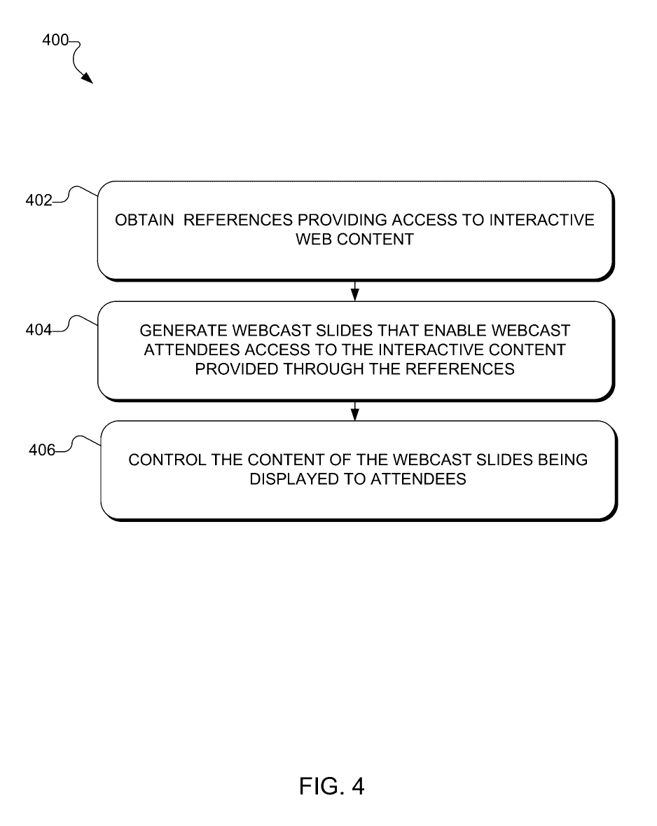

FIG. 4 depicts an example method for providing a webcast with interactive content. At 402, references providing access to interactive web content is obtained at the IWS 114. For example, a presenter provides a list of URLs to the IWS 114. At 404, webcast slides are generated that enable webcast attendees to access to the interactive content provided through the references. Once the webcast slides have been generated and pushed to attendees, the contents of each webcast slide is controlled by a presenter at 406. For example, the presenter may elect to deactivate all or part of the interactive components of the interactive web content exposed through the webcast slide in the frame.

As another example and in one particular embodiment, a table of contents and/or chaptering menu may be generated that is reflective of the content included in the webcast presentation. More specifically, the chaptering menu may include one or more entries that correspond to one or more topical sections, chapters, segments, and/or the like, and any of which identify the various topics that are currently being presented in the webcast presentation, or will be presented in the webcast presentation.

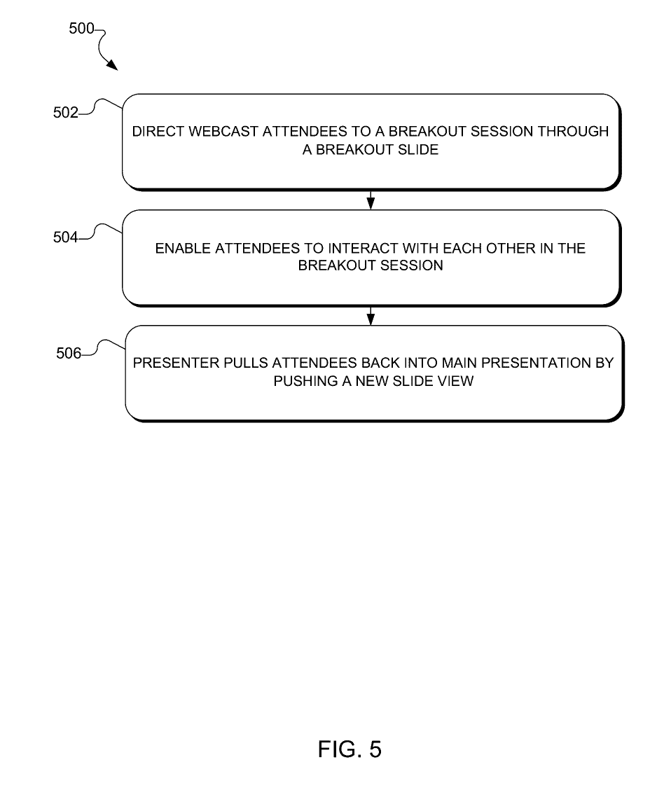

FIG. 5 depicts an example method and/or process for managing a breakout session during an interactive webcast. At 502, attendees are pushed to a breakout session through a webcast slide by a presenter. For example, webcast attendees may be pushed to a webcast slide linking to a third party virtual platform booth. At 504, the presenter allows the attendees in the breakout session to interact. For example, attendees may interact through chat functions.

Once the breakout sessions have been completed, the presenter may push attendees back into the main presentation by pushing another webcast slide at 506.

Thus, as explained above, a webcast presenter may generate webcast slides and present the slides to attendees within a webcast presentation (e.g., users of the attendee user computing devices). In some embodiments, once a live, or on-demand webcast presentation has been initiated, the interactive content module 206 may generate a chaptering menu that includes a series of entries corresponding to one or more of the topical points of interest of the webcast slide(s) currently being presented or otherwise included in the webcast presentation. In one embodiment, the chaptering menu is generated by accessing messages that encapsulate the topical points of interest and which are transmitted from the IWS 114 to one or more of the attendee computing devices (or other client device), currently providing/displaying the chaptering menu, to indicate that a change to the webcast presentation has occurred and therefore an update and/or modification to the chaptering menu should be made.

FIG. 3B provides an example illustration of a chaptering menu 320 that corresponds to a webcast presentation 360, according to one embodiment. As illustrated, the chaptering menu 320 includes a parent window 322 that includes a series of smaller windows or entries 324-330, each of which corresponds to a portion, section, slide, and/or segment, etc., of the webcast presentation 360, such as a webcast slide. The IWS 114 processes each webcast slide included within the webcast presentation 360 to identify the various topics of interests that should be included within the chaptering window as an entry. In one particular embodiment, the chaptering menu is generated by processing, in real-time, unique identifiers, such as a unique key or index that corresponds to each webcast slide included in a webcast presentation. Once a webcast slide is identified, a topical interest of the webcast slide is determined and included as an entry in the chaptering menu 320. Dynamically generating the chaptering menu ensures that the users are provided with a complete and up-to-date list of information that is and will be presented during the webcast presentation. In the illustrated embodiment, the generated chaptering menu is provided to one or more of the attendees of the webcasting presentation at the attendee computing devices 104, 106, 108, or 112.

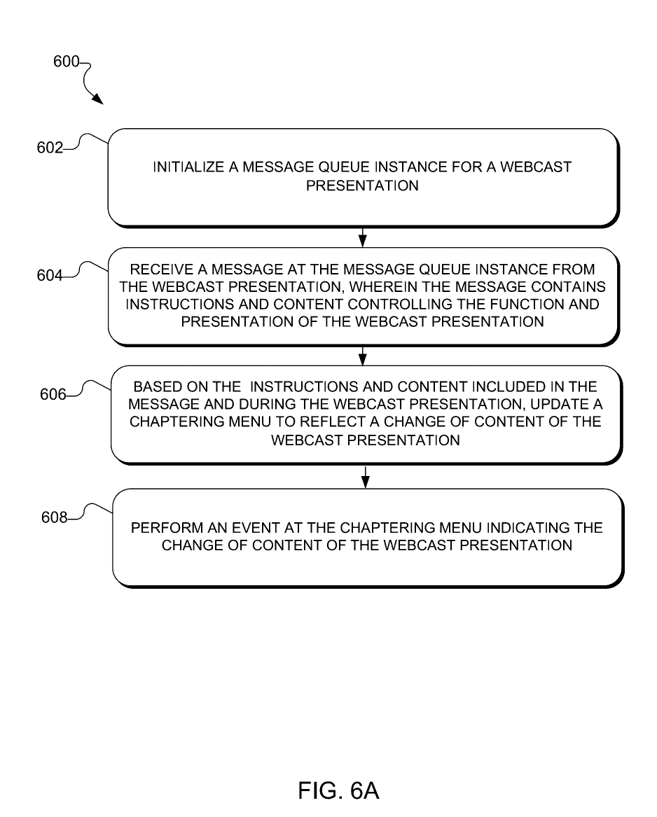

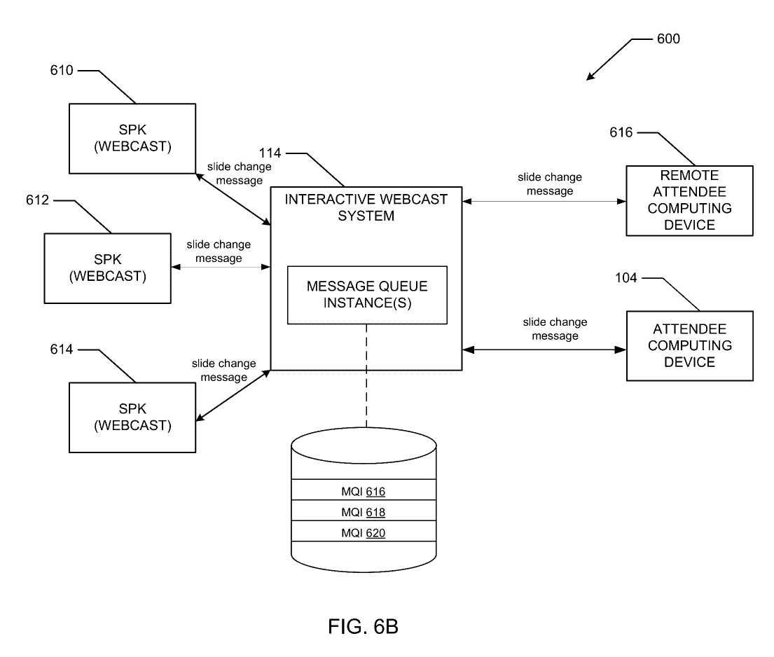

FIGS. 6A provides an example illustration of a process for updating a chaptering menu based on a webcast presentation currently being presented to one or more attendees. As illustrated, at 602, the process begins with initializing a messaging queue instance for a webcast presentation being presented to users (i.e., attendees). Referring to FIG. 6B, assume three webcasts presentations, depicted in the illustrated embodiment as SPKs 610, 612, and 614, were started at the IWS 114 by three different presentation speakers, moderators, etc. For each of the webcast presentations, an instance of a message queue (MQI) 616, 618, and 620 is instantiated. Each message queue instance manages any messages transmitted to the IWS 114 (or polled by the IWS 114) and subsequently transmitted to a remote attendee computing device 616 (operates similar to computing devices 104, 106, and/or 108) or other attendee computing devices, such as the attendee computing device 104.

Referring again to FIG. 6A, at 604, during the presentation of a respective webcast (e.g., SPK 610, 612, 614) messages may be transmitted from an active webcast presentation to the message queue instance corresponding to the webcast presentation. Stated differently, each message queue instance may periodically receive messages from the webcast presentation to which it corresponds. The messages may include, for example, instructions and/or content that controls the function and/or presentation of the webcast presentation currently being provided to the attendee computing devices 104, 106, and 108. The messages may also include indexing data or unique key values that uniquely identify a webcast slide (or other portions of a webcast presentation) and its corresponding topical point(s) of interest, or contents. The identified webcast slide(s) are used to generate an entry in the chaptering menu that is uniquely associated with the webcast slide and reflective of its topical interests and contents.

Thus, assuming the message queue 616 corresponds to the SPK 610, any messages maintained in the message queue 616 could be processed to control the function and/or presentation of the SPK 610. Assuming the message queue 618 corresponds to the SPK 612, any messages maintained in the message queue 618 could be processed to control the function and/or presentation of the SPK 612. And assuming the message queue 620 corresponds to the SPK 614, any messages maintained in the message queue 620 could be processed to control the function and/or presentation of the webcast presentation or otherwise be incorporated into the function and/or presentation of the webcast presentation of the SPK 614. The messages transmitted to each message queue may be transmitted according to various messaging protocols, such as for example hypertext markup language protocol (“HTTP”), real time messaging protocol (“RTMP”), Advanced Messaging Queuing Protocol (“AMQP”), Simple (Streaming) Text Orientated Messaging Protocol (“STOMP”), and/or the like. Any one of such messaging protocols may encapsulate instructions and/or content (e.g., audio, video, streaming data, data) that controls the function and/or presentation of the webcast presentation or is otherwise incorporated into the function and/or presentation of the webcast presentation.

Referring again to FIG. 6A, at 606, the messages queued in each messaging queue instance may be processed to update and/or generate entries of a chaptering menu that are reflective of the current content, or changes in content (e.g., audio, video, streaming data, etc.) occurring at the webcast presentation to which the respective messaging queue instance corresponds. In one embodiment, each attendee computing device participating in the webcast presentation may poll the message queue instance corresponding to the webcast presentation to discover messages indicating a change should be made to the chaptering menu. For example, referring again to FIG. 6B, for users participating in the live webcast presentation SPK 612, the attendee computing devices may poll the message queue instance 618 to detect any messages indicating that changes should be made the chaptering menu corresponding to SPK 612.

Based on the contents of the processed messages, various events may occur at the chaptering menu to illustrate that a change has occurred at the corresponding webcast presentation. For example, based on the processed message, one or more entries in the chaptering menu may be rearranged, due to, for example, a change in the ordering of the content of the corresponding live webcast presentation. As another example, the highlighting of the chaptering element currently being discussed in the webcast may be changed, thereby automatically causing the chaptering menu to scroll. Thus, referring to FIG. 4, entry 424 of the chaptering menu 420 may be traded with entry 430. It is contemplated that any number of entries or combination of entries may be rearranged based on processed messages. As another example, an entry (or a portion of an entry) in the chaptering menu may be highlighted to indicate that the content represented by the entry will be the next topic of interest discussed or otherwise presented during the live webcast presentation.

The description above includes example systems, methods, techniques, instruction sequences, and/or computer program products that embody techniques of the present disclosure. However, it is understood that the described disclosure may be practiced without these specific details.

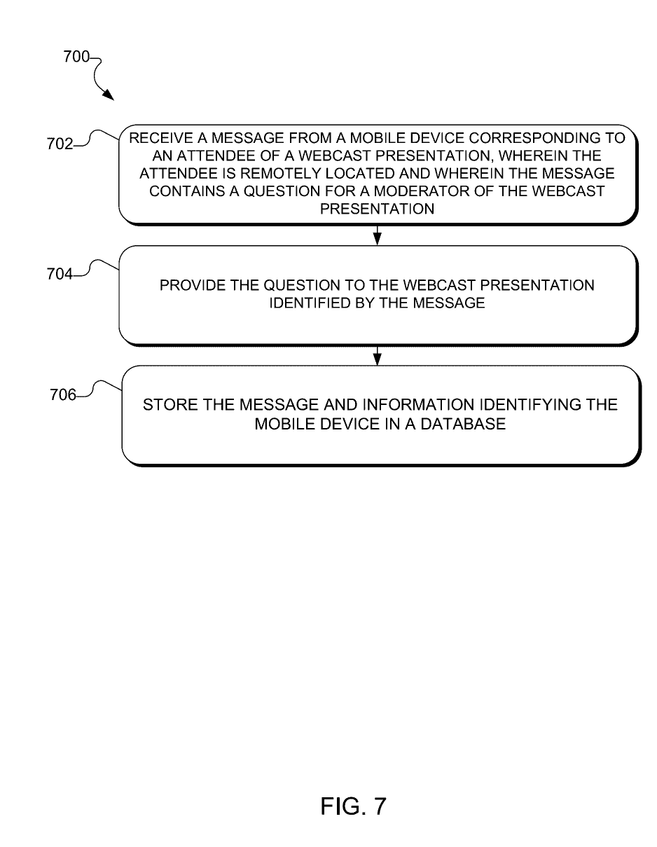

FIG. 7 provides an illustration of a process 700 for enabling remote attendees interacting with mobile devices to participate in webcast presentations, according to one embodiment. As illustrated, at 702, process 700 begins with receiving a message from a remote mobile device that is participating in a webcast event currently being presented at the IWS 114. In one embodiment, the message (similar to other types of messages) may include a code or key value identifying the particular webcast presentation to which the attendee is participating. In another embodiment, the message may also include a question or comment that should be directed to the moderator of the webcast presentation. For example, the message may include a question related to a specific topical interest of one or more of the webcast slides included within the webcast presentation. In one embodiment, each question is submitted to a queue and when new questions arrive, the presenter's question list is updated with the newly submitted question, allowing the question to be either verbally or textually answered. Questions/comments may also be published out to the audience for viewing. Questions may not be systematically tied to slides. For example, the questions may be date stamped and tied to the submitting user.

At 704, the messages are processed and the questions and/or comments are provided to the webcast presentation presenter identified in the message. At 706, any of the messages, together with transmission information such as an identification of the mobile computing device may be stored in a database for later analysis.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Those skilled in the art will appreciate that variations from the specific embodiments disclosed above are contemplated by the invention. The following invention should not be restricted to the above embodiments, but should be measured by the following claims.

What is claimed is:

1. A method for providing interactive content in a webcast comprising:
obtaining, using one or more computing devices, one or more references providing access to interactive web content;
generating, using the one or more computing devices, one or more webcast slides, each of the one or more webcast slides to be rendered inside a self-contained frame, the webcast slide representing the interactive web content accessible through at least one of the references, the one or more webcast slides enabling at least one attendee to access and interact with the interactive web content through the frame;
providing for pushing the one or more webcast slides to the self-contained frame in a host container page of a webcast presentation; and
generating, using the one or more computing devices, a chaptering menu corresponding to the webcast presentation, wherein the chaptering menu includes one or more entries corresponding to a topical interest of the one or more webcast slides.

2. The method of claim 1, further comprising deactivating portions of the interactive web content the at least one attendee may interact with by creating a transparent layer over the interactive web content accessible through the webcast slide that intercepts all click actions and keystrokes by the attendee.

3. The method of claim 1, wherein the providing for pushing includes sending a message comprising a key value identifying a particular webcast slide, the message instructing the self-contained frame to render the particular webcast slide identified by the key value.

4. The method of claim 1, further comprising pushing, during a live webcast, a breakout session webcast slide to at least one other attendee, wherein the at least one attendee and the at least one other attendee are viewing different interactive web content.

5. The method of claim 1, further comprising updating the chaptering menu based on at least one message received by the one or more computing devices.

6. The method of claim 1, further comprising updating the chaptering menu corresponding to the webcast presentation based on at least one message by:
processing the message comprising a key value identifying a particular webcast slide, the slide message instructing the chaptering menu to highlight, a particular entry of the one or more entries, corresponding to the particular webcast slide identified by the key value.

7. A system for providing interactive content in a webcast comprising:
a webcast platform to:
obtaining, using one or more computing devices, one or more references providing access to interactive web content;
generating, using the one or more computing devices, one or more webcast slides, each of the one or more webcast slides to be rendered inside a self-contained frame, the webcast slide representing the interactive web content accessible through at least one of the references, the one or more webcast slides enabling at least one attendee to access and interact with the interactive web content through the frame;
providing for pushing the one or more webcast slides to the self-contained frame in a host container page of a webcast presentation; and
generating, using the one or more computing devices, a chaptering menu corresponding to the webcast presentation, wherein the chaptering menu includes one or more entries corresponding to a topical interest of the one or more webcast slides.

8. The system of claim 7, further comprising deactivating portions of the interactive web content the at least one attendee may interact with by creating a transparent layer over the interactive web content accessible through the webcast slide that intercepts all click actions and keystrokes by the attendee.

9. The system of claim 7, wherein the providing for pushing includes sending a message comprising a key value identifying a particular webcast slide, the message instructing the self-contained frame to render the particular webcast slide identified by the key value.

10. The system of claim 7, further comprising pushing, during a live webcast, a breakout session webcast slide to at least one other attendee, wherein the at least one attendee and the at least one other attendee are viewing different interactive web content.

11. The system of claim 7, further comprising updating the chaptering menu based on at least one message received by the one or more computing devices.

12. The system of claim 7, further comprising updating the chaptering menu corresponding to the webcast presentation based on at least one message by:
processing a message comprising a key value identifying a particular webcast slide, the slide message instructing the chaptering menu to highlight, a particular entry of the one or more entries, corresponding to the particular webcast slide identified by the key value.

13. A method for providing interactive content in a webcast comprising:
storing at least one message in a messaging queue instance maintained by at least one computing device, wherein the messaging queue instance is initialized with the execution of a live webcast presentation;
receiving, by the at least one computing device, at least one message including source information for one or more webcast slides included in the live webcast presentation; and
updating a table of contents corresponding to the live webcast presentation based on the at least one message, wherein the table of contents includes one or more entries corresponding to at least a portion of the one or more webcast slides.

14. The method of claim 13, wherein the at least one webcast slide comprises an index uniquely identifying the at least one webcast slide from other webcast slides included in the live webcast presentation.

15. The method of claim 14, wherein each of the one or more webcast is rendered inside a self-contained frame, and wherein each webcast slide represents interactive web content accessible through at least one of the references, the one or more webcast slides enabling at least one attendee to access and interact with the interactive web content through the self-contained frame.

16. The method of claim 13, further comprising generating the table of contents upon execution of the live webcast presentation.

17. The method of claim 13, further comprising enabling enabling a user to select an entry of the one or more entries in the table of contents without viewing a particular webcast slide of the one or more webcast slide corresponding to the entry in the live webcast presentation.

18. The method of claim 13, further comprising deactivating portions of the interactive web content the at least one attendee may interact with by creating a transparent layer over the interactive web content accessible through the webcast slide that intercepts all click actions and keystrokes by the attendee.
